(19) United States
(12) Patent Application Publication
(10) Pub. No.: US 2025/0222848 A1
(43) Pub. Date: Jul. 10, 2025

(54) TAILGATE INCLUDING TRAY AND METHOD OF SPREADING TRAY AND TRUCK INCLUDING THE SAME

(71) Applicants: Hyundai Motor Company, Seoul (KR); Kia Corporation, Seoul (KR)

(72) Inventors: Un Tae Kim, Suwon-si (KR); Gyeong Min Hwang, Gyeongsangbuk-do (KR)

(21) Appl. No.: 18/629,407

(22) Filed: Apr. 8, 2024

(30) Foreign Application Priority Data
Jan. 4, 2024 (KR) 10-2024-0001690

(51) Int. Cl. B60N 3/00; B62D 35/00

(52) U.S. Cl. CPC B60N 3/002; B62D 35/007

(57) ABSTRACT

An embodiment tailgate includes a tray accommodated in the tailgate, the tray being configured to protrude upwardly and to be folded and unfolded, an actuator disposed in the tailgate and configured to push the tray to protrude upwardly, and a locking member configured to fix a position of the tray in a state in which the tray protrudes outwardly and is unfolded.

### CROSS-REFERENCE TO RELATED APPLICATIONS

This application claims the benefit of Korean Patent Application No. 10-2024-0001690, filed on Jan. 4, 2024, which application is hereby incorporated herein by reference in its entirety.

### TECHNICAL FIELD

The present disclosure relates to a tailgate including a tray, a method of spreading the tray, and a truck including the same.

### BACKGROUND

In addition to the demand for pickup trucks for outdoor work, the popularity of pickup trucks has rapidly increased due to increased demand for pickup trucks for leisure and camping. A tailgate of a pickup truck may be used as a table to hold various items or food, and a cup holder may be used to hold cups therein. Recently, considering the usability thereof, a coaster shape has been applied to an inner trim of the tailgate.

Also, a tailgate may be an important aerodynamic item by being disposed on the rear side of a vehicle and determining a wake size. Since aerodynamics may improve only when an upper end of tailgate receives air flow from a loop, trucks in which an upper end of tailgate is applied in a relatively wide area have been commercialized recently.

Accordingly, recently, there has been a demand for a structure used for various purposes in a tailgate of a pickup truck, and in particular, a structure used for various purposes when a vehicle is traveling or stopping has been necessary.

### SUMMARY

An embodiment of the present disclosure relates to a tailgate spoiler having a structure which may improve both practicality and aerodynamic performance of a tailgate provided in a truck.

The embodiments of the present disclosure are not limited thereto, and a person having ordinary skill in the art will understand that other technical issues not mentioned herein could be address by the configurations used in the specification and drawings.

According to an embodiment of the present disclosure, a tailgate including a tray includes the tray accommodated in the tailgate, protruding upwardly and unfolded, an actuator provided in the tailgate and pushing the tray to protrude upwardly, and a locking member configured to, when the tray protrudes outwardly and is unfolded, fix a position of the tray.

The tray may be connected to an upper portion of the actuator and rotate, and when the tray protrudes outwardly, the tray may rotate to one or both sides and may be unfolded.

Two trays may be provided, and the two trays may be unfolded to an internal side and an external side of the truck, respectively, with respect to the tailgate.

The locking member may include a pair of lockers expandable to both sides, a first elastic member provided between the lockers and pushing the lockers to both sides, a locker body accommodating the lockers therein, and a second elastic member connected to the locker body and pushing the lockers downwardly, in a direction opposite to the direction in which the tray protrudes.

The tailgate may further include a guide member provided on the locker body and pushing the lockers inwardly as the lockers move downwardly.

The lockers may have a tapered shape of which an external surface is inclined downwardly toward an internal side.

An upper portion of the actuator may include a hinge member configured to allow the tray to rotate, and a lower end portion of the hinge member may include a first locking portion caught by a lower end of the locker body.

The tailgate may further include a second locking portion provided in a portion in which the tray is coupled to the hinge member and rotates and receiving an upper end of the locker caught thereby, while the upper end is outwardly expanded after the tray rotates.

When the tray protrudes upwardly and is unfolded, the locker body may be inserted between the first locking portion and the second locking portion.

When the tray moves upwardly, the second locking portion may interfere with the locker and may push the locker inwardly.

When the tray moves inwardly of the tailgate in a folded state, the second locking portion may interfere with the locker and may move downwardly, and the locker may be pressed to an internal side along the guide member.

Two trays may be provided, and the two trays may be unfolded only in opposite directions.

An upper portion of the actuator may include a hinge member in which the tray is provided and rotates, and the hinge member may include a third elastic member applying force in a direction in which the tray is unfolded.

According to an embodiment of the present disclosure, a method of unfolding a tray provided in a tailgate includes a setting operation of selecting a traveling mode as a fuel efficiency mode, a determining operation of monitoring a traveling speed of a vehicle and determining whether a traveling speed is equal to or greater than a predetermined speed, and an unfolding operation of commanding unfolding of a tray when it is determined that the traveling speed is equal to or greater than the predetermined speed.

The method may further include an interference identifying operation of identifying whether the unfolding of the tray will be interfered with before the unfolding operation, wherein the unfolding operation includes a process of selecting whether to unfold one or two trays.

According to an embodiment of the present disclosure, a truck includes a body and a tailgate including a tray provided in the body.

The body may include an operation switch for manipulating an operation of the actuator.

### BRIEF DESCRIPTION OF THE DRAWINGS

The above and other aspects, features, and advantages of embodiments of the present disclosure will be more clearly understood from the following detailed description, taken in conjunction with the accompanying drawings, in which:

FIG. 1 is a perspective diagram illustrating a tailgate including a tray according to an embodiment of the present disclosure;

FIG. 2 is a cross-sectional diagram illustrating a tailgate including a tray according to an embodiment of the present disclosure;

FIGS. 3A and 3B are an internal perspective diagram and a cross-sectional perspective diagram, respectively, illustrating a locking member of a tailgate including a tray according to an embodiment of the present disclosure;

FIG. 4 is a perspective diagram illustrating a state in which a tray has moved up in a tailgate including the tray according to an embodiment of the present disclosure;

FIGS. 5A and 5B are a perspective diagram and a cross-sectional perspective diagram, respectively, illustrating a state in which a tray has moved down in a tailgate, including the tray according to an embodiment of the present disclosure;

FIGS. 6A and 6B are a perspective diagram and a cross-sectional perspective diagram, respectively, illustrating a state in which a tray is moving up in a tailgate, including the tray according to an embodiment of the present disclosure;

FIGS. 7A and 7B are a perspective diagram and a cross-sectional perspective diagram, respectively, illustrating a state in which a tray moves up and is being unfolded in a tailgate including the tray according to an embodiment of the present disclosure;

FIGS. 8A and 8B are a perspective diagram and a cross-sectional perspective diagram, respectively, illustrating a state in which a tray has moved up and unfolded in a tailgate including the tray according to an embodiment of the present disclosure;

FIGS. 9A and 9B are a perspective diagram and a cross-sectional perspective diagram, respectively, illustrating a state in which only a tray on one side has moved up and unfolded in a tailgate including the tray according to an embodiment of the present disclosure;

FIGS. 10A and 10B are a perspective diagram and a cross-sectional perspective diagram, respectively, illustrating a state in which a tray starts being folded in a tailgate, including the tray according to an embodiment of the present disclosure;

FIGS. 11A and 11B are a perspective diagram and a cross-sectional perspective diagram, respectively, illustrating a state in which a tray is being folded in a tailgate, including the tray according to an embodiment of the present disclosure;

FIGS. 12A and 12B are a perspective diagram and a cross-sectional perspective diagram, respectively, illustrating a state in which a tray has moved down in a tailgate, including the tray according to an embodiment of the present disclosure;

FIGS. 13A-13D are diagrams illustrating various usage states of a tray in a tailgate, including the tray according to an embodiment of the present disclosure;

FIGS. 14A and 14B are a perspective diagram and a cross-sectional perspective diagram, respectively, illustrating a state in which a tray has moved down and is fixed in the tailgate while the tailgate is open, including the tray according to an embodiment of the present disclosure; and

FIG. 15 is a flowchart illustrating a method of unfolding a tray according to an embodiment of the present disclosure.

### DETAILED DESCRIPTION OF ILLUSTRATIVE EMBODIMENTS

Hereinafter, embodiments of the present disclosure will be described with reference to the attached drawings. However, redundant descriptions and detailed descriptions of known functions and elements which may unnecessarily make the gist of the present invention obscure will not be provided. In the drawings, components having similar functions and application will be indicated by same reference numerals.

The terms “first,” “second,” and the like may be used to distinguish one element from the other and may not limit a sequence and/or an importance, or others, in relation to the elements. In some cases, a first element may be referred to as a second element, and similarly, a second element may be referred to as a first element without departing from the scope of right of the example embodiments.

The terms such as “part,” “portions,” or the like may be used to describe various components, but the components should not be limited to the terms. The above terms may refer to physically/visually distinct components and also to functions or configurations of the corresponding portion even when a distinction/compartment is not clear.

The terms “include,” “comprise,” “is configured to,” or the like of the description are used to indicate the presence of features, numbers, steps, operations, elements, portions, or combinations thereof, and they do not exclude the possibilities of combination or addition of one or more features, numbers, steps, operations, elements, portions, or combinations thereof.

Unless otherwise indicated, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art and are not to be interpreted as having ideal or excessively formal meanings unless clearly defined as having such in the present application.

In embodiments, a vehicle may refer to a variety of vehicles which may move a transport object, such as a person, animal, or object, from a source to a destination. The vehicle is not limited to vehicles traveling on roads or tracks. Also, an example of the vehicles may include vehicles using fossil fuels such as gasoline, and also secondary batteries using electricity stored in the batteries, and also vehicles using future fuels such as hydrogen.

In the description below, the terms “front side,” “rear side,” “lateral side,” “front,” “back,” “upper and lower,” “above,” “below,” “lower portion,” “left and right,” and the like are defined with respect to a vehicle or a body of a vehicle. Also, the terms including an ordinal number such as “first,” “second,” and so on may be used in the description and the claims to distinguish the elements from one another. These terms are used only for the purpose of differentiating one component from another, without limitation thereto.

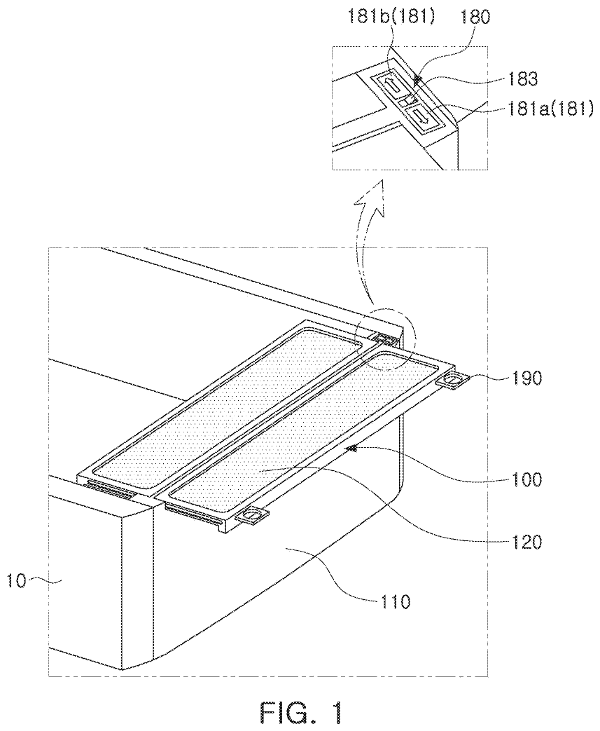

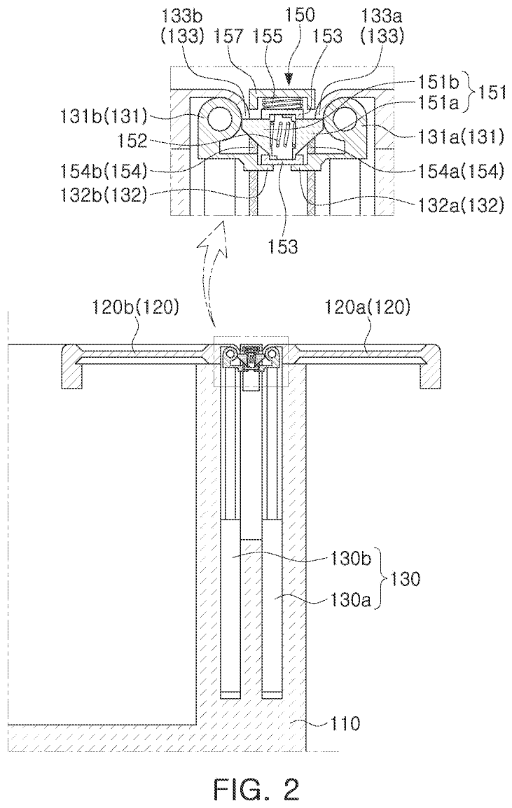

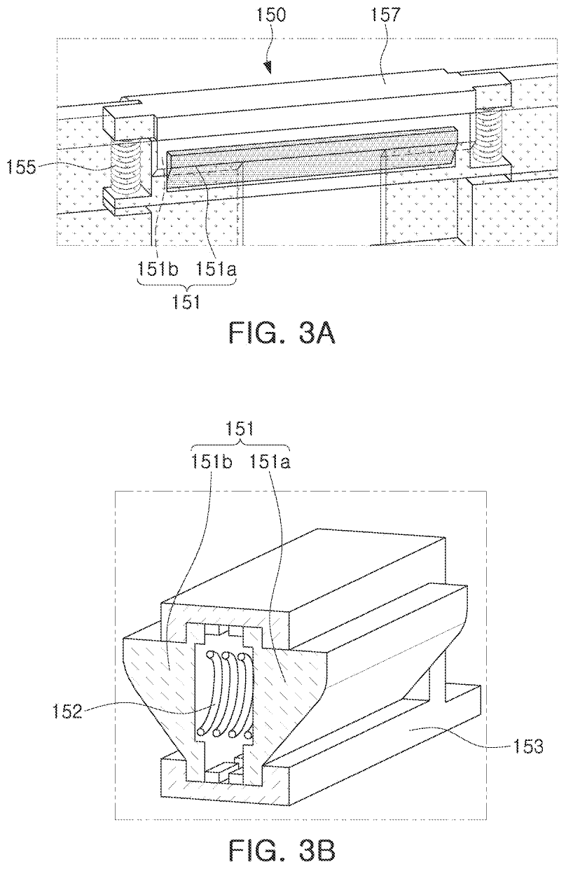

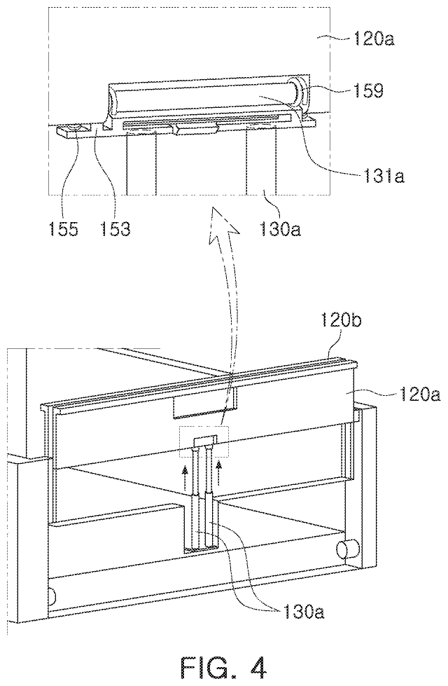

Referring to FIGS. 1 to 4, a combined tailgate and tray 100 in an embodiment may include a tray 120 which may be unfolded outwardly from a tailgate 110. The tray may be unfolded to improve aerodynamics while the vehicle is traveling, or it may be unfolded when the vehicle is stopped to use the tray for various purposes. In embodiments, for ease of description, the tailgate provided in the truck will be described as an example, but an embodiment thereof is not limited thereto, and the truck may include various types of vehicles such as a pickup truck, a sports utility vehicle (SUV), and a jeep including a cargo bed.

A truck including a combined tailgate and tray 100 in an embodiment may include a body 10 and the combined tailgate and tray 100 provided in the body 10. A tray 120 may be driven by an operation switch 180 provided in the body 10. The operation switch 180 may control operation of an actuator operating the combined tailgate and tray 100 in an embodiment.

That is, the tray 120 (e.g., two trays 120a and 120b) may be disposed in a tailgate 110 to define the combined tailgate and tray 100, and when necessary, the trays 120 (120a and 120b) may be unfolded by being pushed outwardly (upwardly) by a driving unit 130 (e.g., driving units 130a and 130b), or the trays 120 may be folded by pulling the trays inwardly (downwardly). The tray 120 may include a first tray 120a unfolded outwardly from the truck and a second tray 120b unfolded toward a cargo bed. If desired, the entirety or only one of the first and second trays 120a and 120b may be unfolded. The trays 120 may have a size slightly smaller than a width of the tailgate 110 and may have a quadrangular shape or may have a rounded outer edge.

The trays 120 (120a and 120b) may be driven by the operation switch 180 provided in the body 10. The operation switch 180 may operate the first and second trays 120a and 120b simultaneously, or it may selectively operate only one tray. For example, selection buttons 181a and 181b may be separated from a driving button 183, it may be selected whether to drive one or both trays by the selection buttons 181a and 181b, and folding or unfolding of the trays may be selected by the driving button 183.

The trays 120 (120a and 120b) may be unfolded to improve aerodynamics when the vehicle is traveling. In this case, when a traveling speed of the vehicle is equal to or higher than a predetermined speed, for example, 80 km/h, the tray may be automatically unfolded by an algorithm for automatically unfolding the tray. The algorithm may be set to fold the tray when a traveling speed of the vehicle decreases below the predetermined speed.

Referring to the attached drawings, the combined tailgate and tray 100 in an embodiment may be provided in the tailgate 110 of the truck, and it may be provided such that the tailgate 110 may be unfolded outwardly from the tailgate 110 or may be pulled back inwardly. The driving may be performed automatically by operation of the operation switch 180 or depending on a speed of the vehicle.

The combined tailgate and tray 100 including the tray 120 in an embodiment may include at least one tray 120 (120a or 120b) which may be unfolded outwardly from the tailgate 110, a driving unit 130 (130a and 130b) moving the trays 120a and 120b upwardly or downwardly, and a locking member 150 for fixing the trays 120a and 120b in an unfolded state.

The trays 120a and 120b may be accommodated in the tailgate 110 of the vehicle and may protrude upwardly and may be unfolded. At least one tray 120a or 120b may be provided, and usually two trays 120a and 120b may be provided such that the trays may be unfolded toward the cargo bed side and the external side of the truck, respectively. Also, the driving units 130a and 130b for driving the trays 120a and 120b may be installed in the first tray 120a and the second tray 120b, respectively, and the first tray 120a and the second tray 120b may be driven individually by each driving unit 130a and 130b.

The trays 120a and 120b may be rotationally connected to an upper portion of the driving units 130a and 130b, and when the trays 120a and 120b protrude outwardly from the tailgate 110, the trays 120a and 120b may rotate toward the cargo bed or the external side, respectively, and may be unfolded. Accordingly, the upper portion of the actuator, which is the driving unit 130a and 130b, may include hinge members 131 (131a and 131b) such that the trays 120a and 120b may rotate. Also, a third elastic member 159 may be provided in the hinge members 131a and 131b, and the third elastic member 159 may apply force in the direction in which the tray 120a or 120b is unfolded such that, when the trays 120a and 120b outwardly protrude from the tailgate 110, the trays 120a and 120b may rotate toward the cargo bed or the external side, respectively, and may be unfolded. For example, the third elastic member 159 may be configured as a torsion spring.

The number of the trays 120a and 120b may be two, and the trays 120a and 120b may be unfolded to the internal side and the external side of the vehicle (truck), respectively, with respect to the tailgate 110.

The driving units 130a and 130b may be provided in the tailgate 110 and may push the trays 120a and 120b to protrude upwardly or may pull the trays 120a and 120b inwardly of the tailgate 110. The driving units 130a and 130b may be configured as hydraulic or pneumatic actuators.

The locking member 150 may fix a position of the trays 120a and 120b when the trays 120a and 120b protrude outwardly from the tailgate 110 and are unfolded.

The locking member 150 may include a pair of lockers 151 (151a and 151b), a first elastic member 152 which may be provided between the lockers 151a and 151b and may push the lockers 151a and 151b to both sides, a locker body 153 accommodating the lockers 151a and 151b therein, and a second elastic member 155 connected to the locker body 153 and exerting an elastic force downwardly in the direction in which the trays 120a and 120b of the lockers 151a and 151b protrude from the tailgate 110 or in the opposite direction. The first elastic member 152 and the second elastic member 155 may be configured as coil springs. One end of the second elastic member 155 may be connected to the locker body 153 and the other end may be connected to a locker cover 157 covering the locker body 153. The locker cover 157 may be configured as a cover for covering an upper portion of the tailgate 110.

When the trays 120a and 120b are pushed outwardly from the tailgate 110 by the driving units 130a and 130b, the trays 120a and 120b may rotate and may be unfolded by the hinge members 131a and 131b by the third elastic member 159, and a lower end portion of the locker body 153, which accommodates the lockers 151a and 151b therein, may be caught by a first locking portion 132 (132a and 132b) provided on the hinge members 131a and 131b. When upper ends of the lockers 151a and 151b expand outwardly after the trays 120a and 120b rotate, the lockers 151a and 151b may be caught by the second locking portions 133a and 133b provided in a rotating portion of the hinge members 131a and 131b.

The second locking portions 133a and 133b may interfere with the lockers 151a and 151b when the trays 120a and 120b move upwardly and are unfolded in a folded state, and in this case, the lockers 151a and 151b may be inwardly pushed temporarily, and due to a restoring force of the first elastic member 152, the lockers 151a and 151b may expand outwardly and may be caught by the second locking portions 133a and 133b provided on end portions of the folded trays 120a and 120b.

Here, the second locking portions 133a and 133b may be provided in a stepped shape in a portion in which end portions of the trays 120a and 120b rotate along the hinge members 131a and 131b.

In other words, when the trays 120a and 120b protrude outwardly from the tailgate 110 and unfold, the locker body 153 having the lockers 151a and 151b may be inserted between the first locking portions 132a and 132b and the second locking portions 133a and 133b, and accordingly, the trays 120a and 120b may be firmly fixed in the unfolded state.

The lockers 151a and 151b may be provided in a tapered shape of which an external surface may be inclined toward an internal side downwardly, and the lockers 151a and 151b may be pushed inwardly, which is the direction opposite to each other, as the lockers move downwardly. Accordingly, the first elastic member 152 may be compressed and the lockers 151a and 151b may receive force of being pushed outwardly.

The locker body 153 may include guide members 154 (154a and 154b) fixed to the immediate lower portion of the lockers 151a and 151b, and when the lockers 151a and 151b move downwardly, the inclined tapered external surface of the lockers 151a and 151b may be pushed inwardly along an inner surface of the guide members 154a and 154b. Accordingly, the trays 120a and 120b may be unfolded outwardly such that the second locking portions 133a and 133b caught by the lockers 151a and 151b may be released, and as the trays 120a and 120b are folded, a path through which the tailgate 110 may move inwardly may be formed.

The number of the trays 120a and 120b may be two, and the trays 120a and 120b may be configured to unfold only in opposite directions. Accordingly, two trays may be unfolded simultaneously or only one tray may be unfolded.

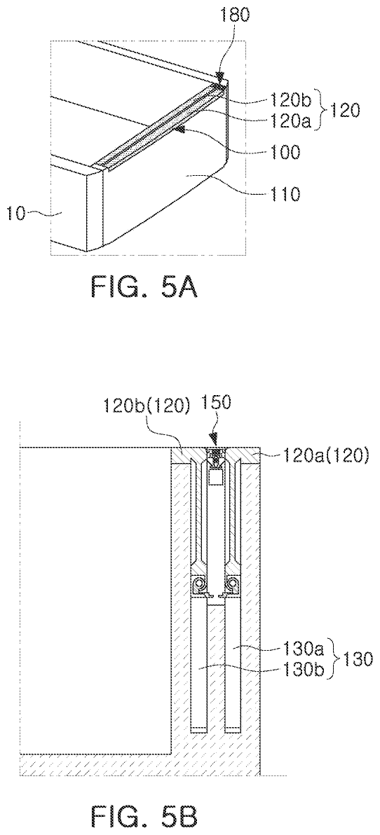

FIGS. 5A to 8B illustrate an example of a process in which the trays 120a and 120b in the tailgate 110 move up and unfold.

Referring to FIG. 5A, the trays 120a and 120b may be fixed in the tailgate 110, and accordingly, the driving units 130a and 130b may pull the trays 120a and 120b to a lowermost portion as illustrated in FIG. 5B.

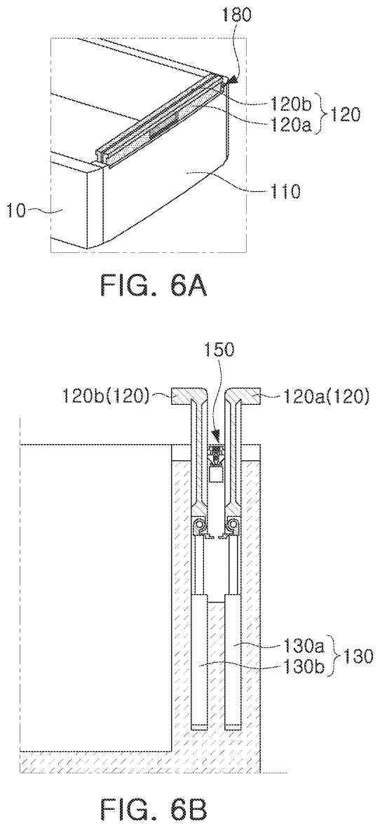

Referring to FIG. 6A, the trays 120a and 120b may partially protrude outwardly from the tailgate 110, and accordingly, the driving units 130a and 130b may partially push the trays 120a and 120b upwardly as illustrated in FIG. 6B.

In the example in FIGS. 5A, 5B, 6A, and 6B, while the lockers 151a and 151b of the locker body 153 are pushed inwardly, the first elastic member 152 provided between therebetween may exert a force to push the lockers 151a and 151b outwardly.

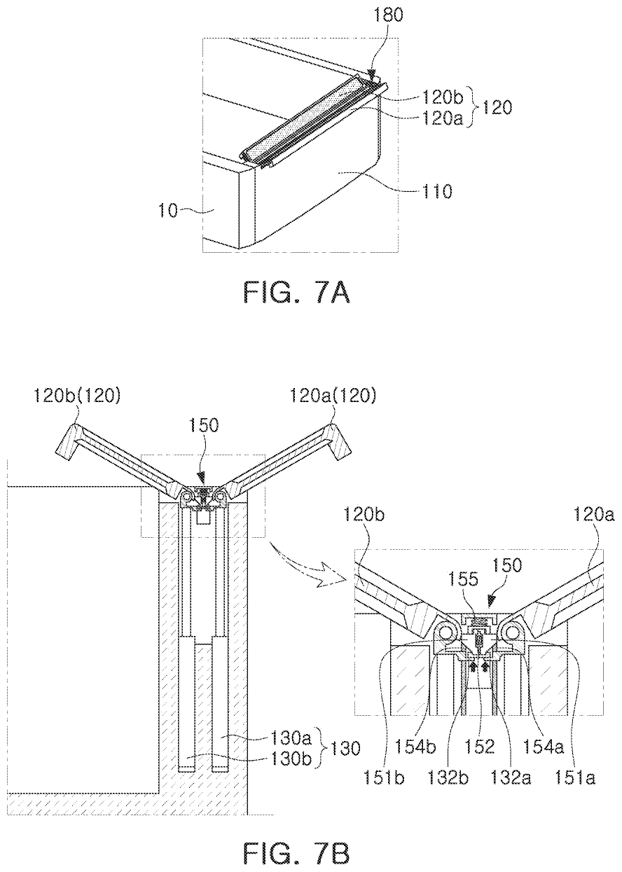

Referring to FIG. 7A, most of the trays 120a and 120b may protrude outwardly from the tailgate 110 and start unfolding, and accordingly, the driving units 130a and 130b may push the trays 120a and 120b upwardly, and the trays 120a and 120b may be unfolded to the external side by the third elastic member 159 as illustrated in FIG. 7B.

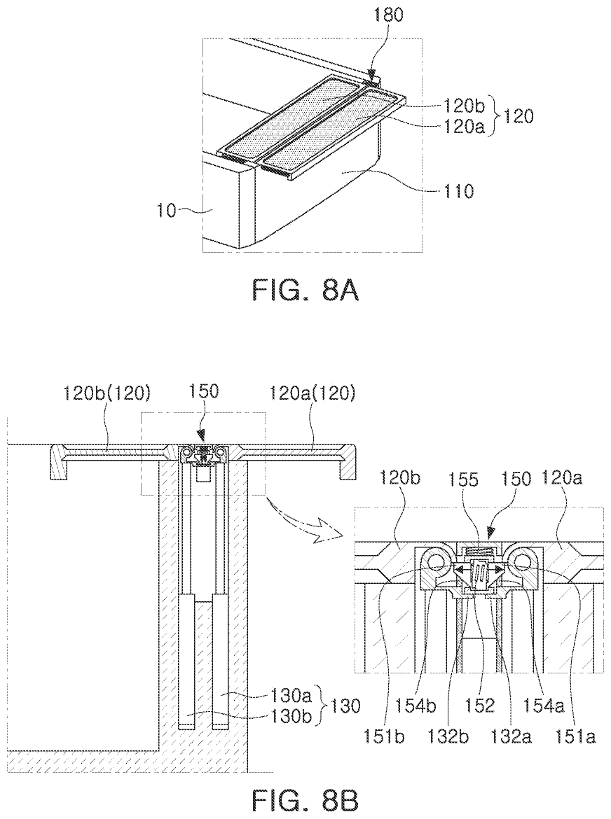

Referring to FIG. 8A, the trays 120a and 120b protrude outwardly of the tailgate 110 to the end and fully unfold, and accordingly, the driving units 130a and 130b may push the trays 120a and 120b to an upper end, the trays 120a and 120b may be unfolded to the external side by the third elastic member 159, a lower end portion of the locker body 153 may be caught by the first locking portions 132a and 132b of the hinge members 131a and 131b having moved up, and as the trays 120a and 120b rotate to the end, when the force pressing the lockers 151a and 151b is released and the upper end is extended outwardly, the lockers 151a and 151b may be caught by the second locking portions 133a and 133b provided in the rotating portion of the hinge members 131a and 131b, such that the trays 120a and 120b may be firmly fixed as illustrated in FIG. 8B.

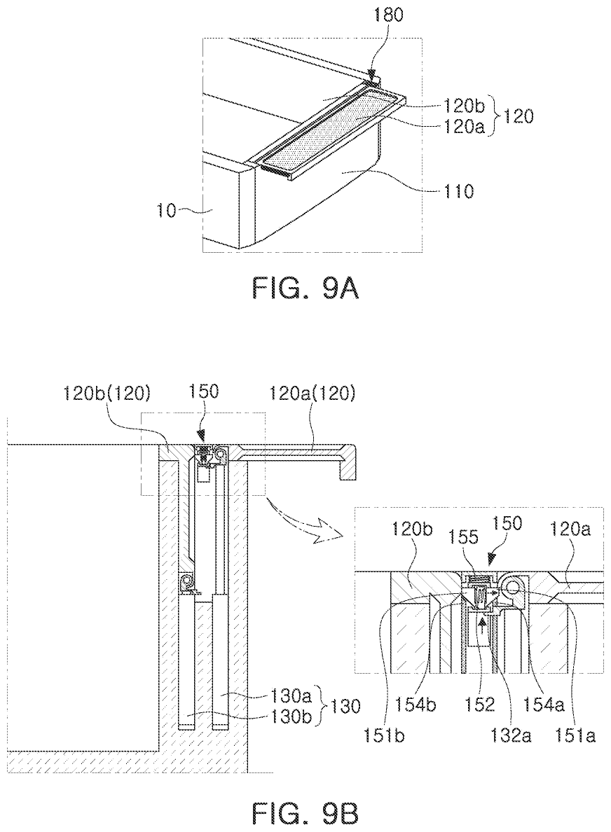

FIGS. 9A and 9B illustrate an example in which, among the trays 120 in the tailgate 110, only one tray 120a on the external side moves up and is unfolded. However, the shape of the other tray 120b when unfolded may be substantially the same, and the description thereof will not be provided.

When only one tray 120a protrudes and is unfolded outwardly from the tailgate 110, the tray 120a may move upwardly by operating only one driving unit 130a linked to the tray 120a to be unfolded among the driving units 130a and 130b. Accordingly, one tray 120a may move upwardly and is unfolded, and the other tray 120b may remain fixed in the tailgate 110.

The process of protruding the first tray 120a outwardly may differ only in that only one driving unit 130a may be driven instead of two, and the other configuration may be the same as the example described with reference to FIGS. 5A to 7B, and the detailed description thereof will thus not be provided.

As illustrated in FIGS. 9A and 9B, when only the first tray 120a is unfolded, the locking member 150 may also operate to fix only the first tray 120a. In the drawing, the reference number with “a” denoted at the end thereof may refer to the first tray 120a or devices linked thereto, and the reference number with “b” denoted at the end thereof may refer to the second tray 120b or devices linked thereto.

That is, the first tray 120a may protrude outwardly from the tailgate 110 and may be fully unfolded as shown in FIG. 9A, and accordingly, the first driving unit 130a may push the first tray 120a to the upper end, the first tray 120a may be unfolded to the external side by the third elastic member 159, a lower end portion of the locker body 153 may be caught by the first locking portion 132a of the first hinge member 131a having moved up, and as the first tray 120a rotates to the end, and when the force pressing the first locker 151a is released and the upper end extends outwardly, the tray 120a may be firmly fixed by being caught by the first locker 151a in the second locking portion 133a provided in the portion in which the first hinge member 131a rotates as shown in FIG. 9B. Here, the second tray 120b may maintain a fixed state, and accordingly, the second locker 151b may maintain a fixed state even when the first locker 151a is expanded.

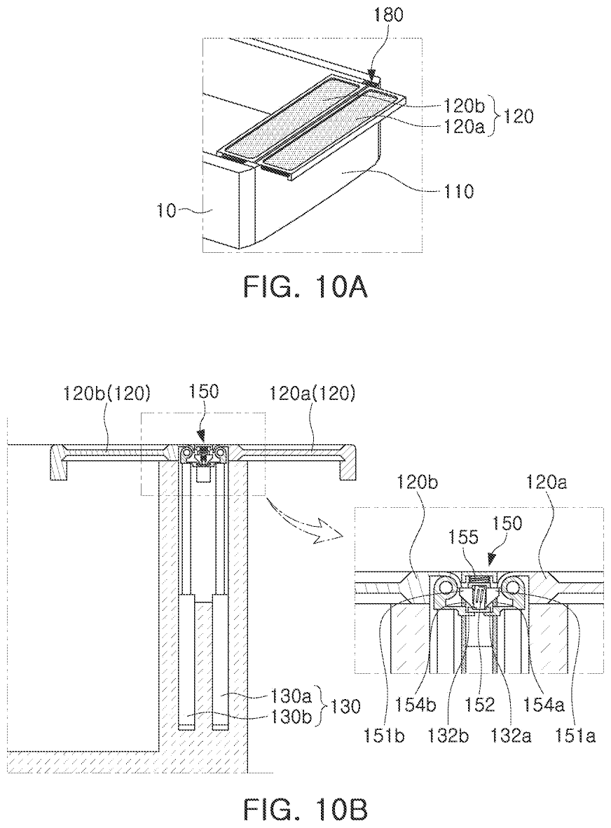

FIGS. 10A to 12B illustrate an example of a process of folding the trays 120a and 120b having been unfolded outwardly from the tailgate 110.

Referring to FIG. 10A, the trays 120a and 120b may be unfolded outwardly from the tailgate 110, and accordingly, the driving units 130a and 130b may push the trays 120a and 120b upwardly as illustrated in FIG. 10B.

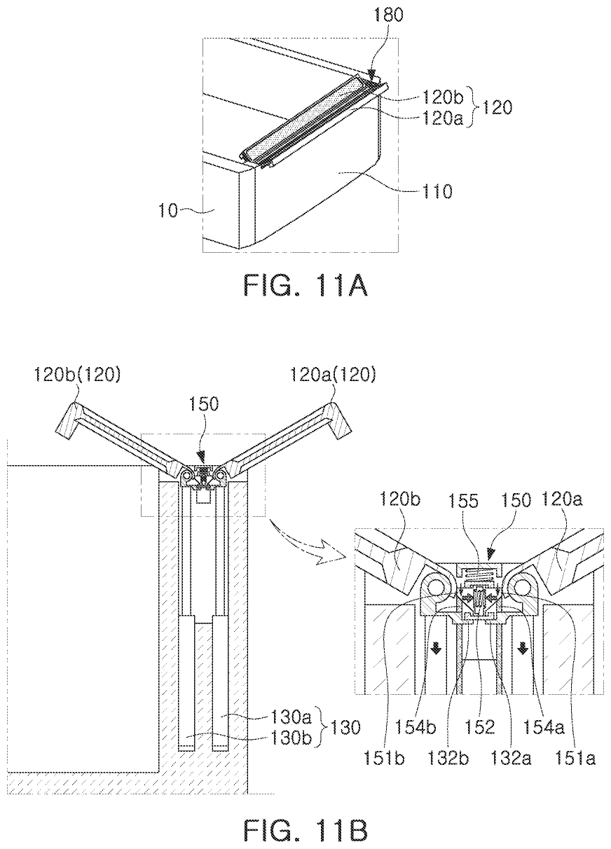

Referring to FIG. 11A, the trays 120a and 120b having been unfolded outwardly from the tailgate 110 may start folding, and accordingly, the driving units 130a and 130b may partially pull the trays 120a and 120b downwardly, and the trays 120a and 120b having been unfolded to the external side may be folded by the third elastic member 159. Also, as the first locking portions 132a and 132b move downwardly along the driving units 130a and 130b, the lower end of the locker body 153 may be released, and the lockers 151a and 151b caught by the second locking portions 133a and 133b may be pushed downwardly, and accordingly, the inclined tapered external surface of the lockers 151a and 151b may be pushed inwardly along the inner surface of the guide members 154a and 154b such that the trays 120a and 120b may be folded again to follow the driving direction of the driving units 130a and 130b as illustrated in FIG. 11B.

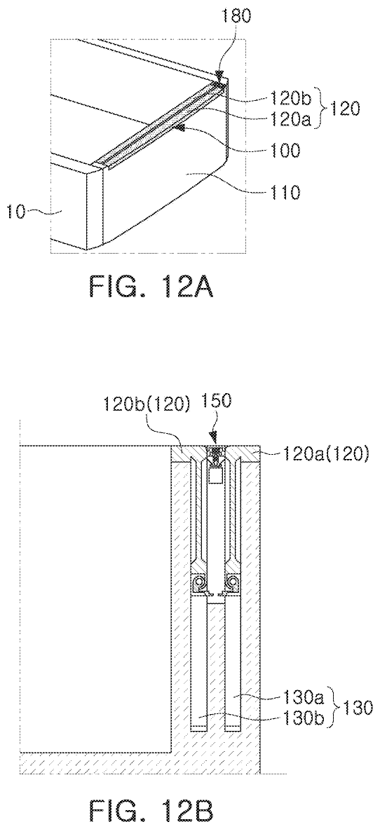

Referring to FIG. 12A, the trays 120a and 120b may be aligned with the driving direction such that the trays may enter the tailgate 110, and accordingly, the driving units 130a and 130b may pull the trays 120a and 120b downwardly to the end as illustrated in FIG. 12B.

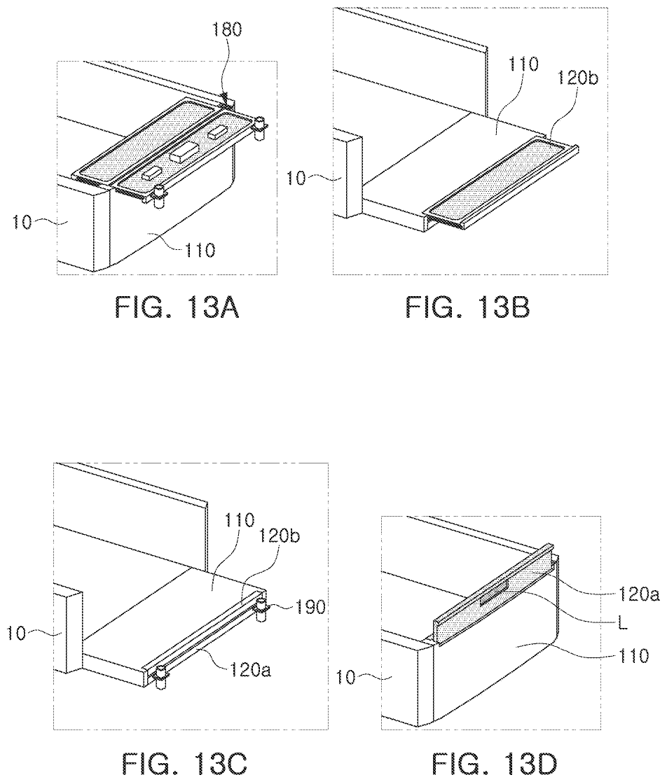

Referring to FIGS. 13A-13D, various examples in which the combined tailgate and tray 100 according to an embodiment is used.

FIG. 13A illustrates a state in which both trays 120a and 120b of the combined tailgate and tray 100 are unfolded, and a cup holder 190 provided in the trays 120a and 120b may be used.

FIG. 13B illustrates a shape of the second tray 120b of the combined tailgate and tray 100 which protrudes outwardly while the tailgate 110 provided in the truck in the embodiment is open. However, in this case, as the second tray 120b may automatically rotate upwardly by the third elastic member 159, instead of pushing the second tray 120b to the end, the second tray 120b may partially remain in the tailgate 110, or luggage may be placed on the upper portion of the second tray 120b.

When the second tray 120b is outwardly exposed and not folded, a portion of a surface of the second tray 120b may be in close contact with a side surface of the locker cover 157, and the first locking portion 132b, which is an end portion of the second tray 120b, may be caught by the hinge member 131b and may remain fixed even in the unfolded state.

Also, referring to FIG. 13C, when the tailgate 110 is open, none of the trays 120 may protrude and only the cup holder 190 provided in the first tray 120a may be used.

Also, referring to in FIG. 13D, while the tailgate 110 is closed, only the first tray 120a may protrude outwardly such that a light L attached to the backside surface of the first tray 120a may be used. The light L may be removable or may be permanently attached. When light Lis removable, an outlet which may supply power, such as a USB jack, may be provided on the backside surface of the first tray 120a.

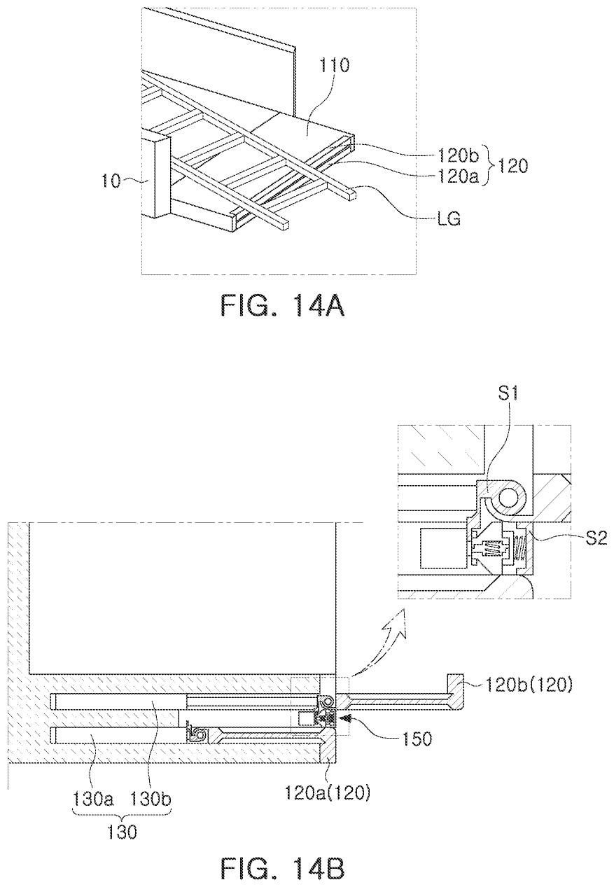

Referring to FIGS. 14A and 14B, as illustrated in FIG. 13B, a loading space of the truck may be increased by unfolding the second tray 120b while the tailgate 110 is open. When loading a long luggage LG into a cargo bed of a truck, the luggage may be supported by unfolding the second tray 120b while the tailgate 110 is open.

Even when the second tray 120b protrudes to the external end of the tailgate 110 and the luggage LG is loaded thereon, the luggage may be supported without being bent to the external side by the locking member 150 supporting the second tray 120b.

In other words, when the second tray 120b protrudes to the end by the second driving unit 130b, the lower end portion of the locker body 153 may be caught by the first locking portion 132b provided in the hinge member 131b. Even when the luggage is loaded on the upper portion, the second tray 120b may remain extended without being folded by the first support portion S1 in which the second locking portion 133b provided in the second tray 120b is supported on the side surface of the hinge member 131b and the second support portion S2 in which the other portion of the second tray 120b is supported on the upper side of the locker body 153.

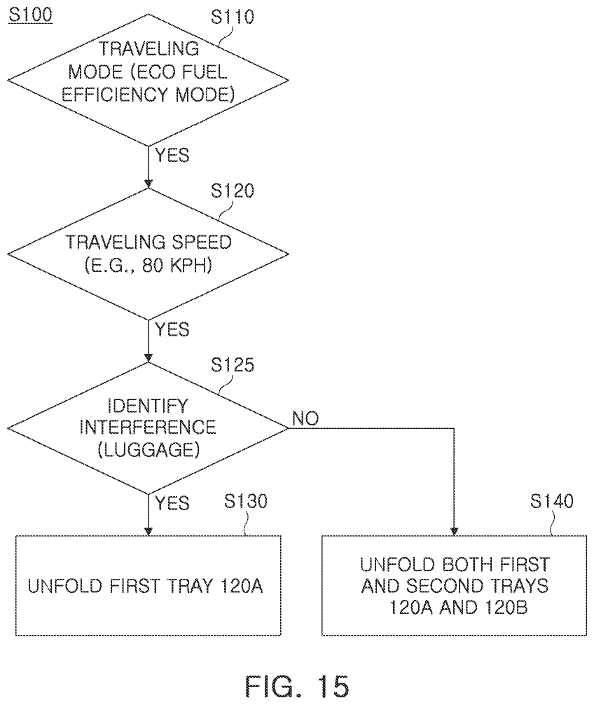

Referring to FIG. 15, an embodiment may include a method of unfolding a tray (S100) of automatically unfolding the tray depending on a traveling speed of the combined tailgate and tray 100.

The method of unfolding a tray (S100) in the embodiment may include a setting operation (S110) of selecting a traveling mode as a fuel efficiency mode, a determining operation (S120) of monitoring a traveling speed of the vehicle and determining whether the traveling speed is equal to or greater than a predetermined speed, and an unfolding operation of commanding the unfolding of the tray when it is determined that the traveling speed is equal to or greater than the predetermined speed (S130 or S140). Also, when cargo is loaded on the cargo bed of the truck, interference with luggage may be determined and it may be controlled such that only the outwardly unfolded tray may be unfolded.

Accordingly, the embodiment may include an interference identifying operation (S125) of identifying whether the unfolded tray interferes before the unfolding operation (S130 or S140). The unfolding operation (S130 or S140) may include the process of selecting whether to unfold one or two trays.

The setting operation (S110) may be a process in which a user selects a traveling method of the vehicle as ‘fuel efficiency mode,’ and accordingly, the tray provided in the tailgate of the truck may be unfolded for vehicle traveling. By unfolding the tray, aerodynamic performance may be improved when the vehicle is traveling.

The determining operation (S120) may include determining whether the traveling speed of the vehicle is equal to or greater than a predetermined speed—for example, 80 km/h. When the vehicle speed is equal to or greater than a predetermined speed, the unfolding of the tray may affect aerodynamics. When the speed decreases, the decrease in speed may be determined and the unfolded tray may be commanded to be folded.

The interference identifying operation (S125) may include identifying whether the unfolding of the tray will be interfered with by the luggage in the cargo bed of the truck. To identify whether luggage interferes with the cargo bed, common methods such as ultrasonic/laser sensors may be used.

The unfolding operation (S130 or S140) may include unfolding the tray by receiving a command from the controller as to whether the tray is unfolded. When it is determined that the luggage interferes with the cargo bed, only the tray 120a able to be unfolded outwardly from the cargo bed may be unfolded (S130). When it is determined that the luggage does not interfere, both of the trays 120a and 120b on both sides may be commanded to unfold (S140).

When the unfolding of the tray is commanded by the controller, the driving units 130a and 130b linked to the trays 120a and 120b may operate such that the trays 120a and 120b may be unfolded.

The unfolding device of the tray for driving the method of unfolding a tray (S100) in the embodiment may be provided to interoperate with the combined tailgate and tray 100.

Although not illustrated in the drawings, the unfolding device of the tray may include a traveling-mode setting portion, a traveling-speed determination portion, an interference identifying portion, and a controller.

The traveling-mode setting portion may allow a user to select a traveling method of the vehicle as ‘fuel efficiency mode,’ and the traveling mode determined thereby may be received by the controller. As the traveling-mode setting portion, a user interface, a center fascia, and the like provided in the vehicle may be used, or the portion may be configured as a pre-determined mode when the vehicle is launched.

The traveling speed determination portion may determine whether the traveling speed of the vehicle is equal to or greater than a predetermined speed, 80 KPH for example, and may transmit the corresponding information to the controller. Even when the speed decreases, the decrease in speed may be determined and the corresponding information may be transmitted to the controller.

The interference identifying portion may be used to identify whether the unfolding of the tray will be interfered with by the luggage in the cargo bed of the truck. To identify whether the luggage interferes with the cargo bed, common methods such as ultrasonic/laser sensors may be used, and the corresponding information may be transmitted to the controller.

The controller may be connected to the traveling-mode setting portion, the traveling speed determination portion, and the interference identifying portion and may receive or transmit an electrical control signal. The controller may command whether to unfold the tray through information received from the traveling-mode setting portion, the traveling speed determination portion, and the interference identifying portion.

When it is determined that the luggage interferes with the cargo bed, it may be commanded that only the tray 120a able to be unfolded outwardly from the cargo bed may be unfolded, and when it is determined that the luggage does not interfere, it may be commanded that both trays 120a and 120b on both sides may be unfolded.

When the controller commands the unfolding of the trays, the driving units 130a and 130b linked to the trays 120a and 120b may operate and the trays 120a and 120b may be unfolded.

The methods in the embodiments may be implemented in the form of program instructions executed through various computer means and recorded on a computer-readable medium. A computer-readable medium may include program instructions, data files, data structures, and the like, singly or in combination. Program instructions written on a computer-readable medium may be specially designed and configured for embodiments of the present disclosure or may be known and usable by those skilled in the computer software art.

Examples of a computer-readable medium may include hardware devices specially configured to store and execute program instructions, such as ROM, RAM, flash memory, and the like. Examples of program instructions may include machine language code produced by a compiler and also high-level language code which may be executed by a computer using an interpreter. The above-described hardware device may be configured to operate with at least one software module to perform operations of embodiments of the present disclosure and vice versa.

The unfolding device of the tray in an embodiment may include a storage portion (not illustrated). The storage portion may be implemented as a recording medium suitable for storing the method of unfolding a tray (S100), such as magnetic media such as a hard disk, a floppy disk, and a magnetic tape, an optical media such as a compact disk read only memory (CD-ROM), a digital video disk (DVD), a magneto-optical media such as a floptical disk, a semiconductor memory such as a flash memory, an erasable programmable ROM (EPROM), or SSDs manufactured based thereon.

Embodiments of the present disclosure may be implemented by a non-volatile memory (not illustrated) configured to store data relating to an algorithm configured to control operation of various components of the vehicle, software instructions for reproducing the algorithm, and a processor (not illustrated) configured to perform operations described above or below using data stored in the corresponding memory. Here, the memory and the processor may be implemented as individual chips. Alternatively, the memory and the processor may be implemented as a single chip integrated with each other. A processor may be configured to include one or more processors.

The components of the method of unfolding a tray (S100) may be connected in a wired manner and wirelessly and may exchange information using a network provided in the vehicle. For example, data may be exchanged using the network communication means provided in the vehicle, such as Ethernet, media oriented systems transport (MOST), Flexray, controller area network (CAN), local interconnect network (LIN), Internet, LTE, 5G, Wi-Fi, Bluetooth, near field communication (NFC), Zigbee, radio frequency (RF), and low frequency (LF).

According to the aforementioned embodiments, a truck having a tailgate which may include a tray may provide a tailgate spoiler which may improve both practicality and aerodynamic performance of the tailgate.

The effects of embodiments of the present disclosure are not limited to the above-described effects, and a person skilled in the art will understand that other effects not mentioned may be derived from the configurations used in the specification and drawings.

While the embodiments have been illustrated and described above, it will be apparent to those skilled in the art that modifications and variations could be manufactured without departing from the scope of the present disclosure as defined by the appended claims.

What is claimed is:

1. A tailgate comprising:
a tray accommodated in the tailgate, the tray being configured to protrude upwardly and to be folded and unfolded;
an actuator disposed in the tailgate and configured to push the tray to protrude upwardly; and
a locking member configured to fix a position of the tray in a state in which the tray protrudes outwardly and is unfolded.

2. The tailgate of claim 1, wherein:
the tray is connected to an upper portion of the actuator and is rotatable; and
in a state in which the tray protrudes outwardly, the tray is configured to rotate to one or both sides and be unfolded.

3. The tailgate of claim 2, wherein:
the upper portion of the actuator comprises a hinge member to which the tray is coupled to be rotatable; and
the hinge member comprises an elastic member configured to apply a force in a direction in which the tray is unfolded.

4. The tailgate of claim 1, wherein:
the tray comprises a first tray and a second tray; and
the first tray is configured to be unfolded to an internal side of a vehicle and the second tray is configured to be unfolded to an external side of the vehicle, respectively, with respect to the tailgate.

5. The tailgate of claim 1, wherein the locking member comprises:
a pair of lockers expandable to both sides of the locking member;
a first elastic member disposed between the pair of lockers and pushing the pair of lockers to both sides;
a locker body accommodating the pair of lockers therein; and
a second elastic member connected to the locker body and configured to push the pair of lockers downwardly in a direction opposite to a direction in which the tray protrudes.

6. The tailgate of claim 5, further comprising a guide member disposed on the locker body and configured to push the pair of lockers inwardly as the pair of lockers moves downwardly.

7. The tailgate of claim 6, wherein the pair of lockers has a tapered shape of which an external surface is inclined downwardly toward an internal side.

8. The tailgate of claim 7, wherein, in a state in which the tray moves inwardly of the tailgate in a folded state, a locking portion is configured to interfere with the pair of lockers and move downwardly, and the pair of lockers is pressed to the internal side along the guide member.

9. The tailgate of claim 5, wherein:
an upper portion of the actuator comprises a hinge member configured to allow the tray to rotate; and
a lower end portion of the hinge member comprises a first locking portion configured to be caught by a lower end of the locker body.

10. The tailgate of claim 9, further comprising a second locking portion disposed in a portion in which the tray is coupled to the hinge member and configured to receive an upper end of the pair of lockers caught thereby in a state in which the upper end is outwardly expanded after the tray rotates.

11. The tailgate of claim 10, wherein, in a state in which the tray protrudes upwardly and is unfolded, the locker body is inserted between the first locking portion and the second locking portion.

12. The tailgate of claim 10, wherein, in a state in which the tray moves upwardly, the second locking portion is configured to interfere with the pair of lockers and push the pair of lockers inwardly.

13. The tailgate of claim 1, wherein:
the tray comprises a first tray and a second tray; and
the first tray and the second tray are configured to be unfolded in opposite directions.

14. A method of unfolding a tray provided in a tailgate, the method comprising:
a setting operation of selecting a traveling mode as a fuel efficiency mode;
a determining operation of monitoring a traveling speed of a vehicle and determining whether the traveling speed is equal to or greater than a predetermined speed; and
an unfolding operation of commanding the unfolding of the tray in response to a determination that the traveling speed is equal to or greater than the predetermined speed.

15. The method of claim 14, further comprising an interference identifying operation of identifying whether the unfolding of the tray will be interfered with before the unfolding operation.

16. The method of claim 15, wherein:
the tray comprises a first tray and a second tray; and
the unfolding operation comprises a process of selecting whether to unfold the first tray or unfold the first tray and the second tray.

17. The method of claim 16, wherein the process of selecting whether to unfold the first tray or unfold the first tray and the second tray is based on a determination of the interference identifying operation.

18. A vehicle comprising:
a vehicle body comprising a tailgate; and
a tray disposed in the tailgate, the tray being configured to protrude upwardly and to be folded and unfolded.

19. The vehicle of claim 18, wherein the body comprises an operation switch configured to manipulate an operation of an actuator to move the tray.

20. The vehicle of claim 18, further comprising:
an actuator disposed in the tailgate and configured to push the tray to protrude upwardly; and
a locking member configured to fix a position of the tray in a state in which the tray protrudes outwardly and is unfolded.
